(19) United States
(12) Patent Application Publication
(10) Pub. No.: US 2021/0310634 A1
(43) Pub. Date: Oct. 7, 2021

(54) LIGHTING DEVICE

(71) Applicant: SHARP KABUSHIKI KAISHA, Sakai City, Osaka (JP)

(72) Inventors: TOSHIYUKI NOBUOKA, Sakai City, Osaka (JP); SHUMPEI NISHINAKA, Sakai City, Osaka (JP); KYOKO MATSUURA, Sakai City, Osaka (JP); SHUN UEKI, Sakai City, Osaka (JP); TSUYOSHI KAMADA, Sakai City, Osaka (JP)

(21) Appl. No.: 17/271,417

(22) PCT Filed: Aug. 26, 2019
(86) PCT No.: PCT/JP2019/033358

§ 371 Date: Feb. 25, 2021

(30) Foreign Application Priority Data
Aug. 28, 2018 (JP) 2018-159204

(51) Int. Cl. F21V 7/04; F21V 17/10; F21S 11/00

(52) U.S. Cl. CPC F21V 7/04; F21S 11/002; F21V 17/101

(57) ABSTRACT

Provided is a lighting device that can be easily attached to and removed from a panel. The lighting device includes a lighting film including a prism layer configured to emit incident light toward a prescribed direction as emitted light and a double-sided adhesive adhering to at least a part of an outer periphery of the lighting film and including both surfaces having adhesiveness on a side of the incident light and a side of the emitted light, wherein at least one of a peeling strength and a shear bonding strength on the side of the incident light is less than that on the side of the emitted light.

### TECHNICAL FIELD

The disclosure relates to a lighting device.

### BACKGROUND ART

PTL 1 discloses a lighting sheet 20 in which a bonding layer 26 is provided on the entire surface of the lighting sheet 20 to allow the lighting sheet 20 to adhere to a panel 13.

This application claims priority to Japanese Patent Application No. 2018-159204 filed in Japan on Aug. 28, 2018, the entire contents of which are hereby incorporated by reference.

### CITATION LIST

### Patent Literature

PTL 1: JP 2014-119738 A

### SUMMARY OF INVENTION

### Technical Problem

However, in the configuration described in PTL 1, light that enters through a part at which the bonding layer and a light transmission part are in contact with each other is direct leakage light that does not travel through a light deflector, which causes glare, and, in some cases, inhibits achievement of expected polarization performance.

One aspect of the present invention is made in view of the problem of the known technique described above, and an object thereof is to provide a lighting device that can be easily attached to and removed from a panel.

### Solution to Problem

To solve the problem described above, a lighting device according to one aspect of the present invention includes a lighting film including a prism layer configured to emit incident light toward a prescribed direction as emitted light and a double-sided adhesive adhering to at least a part of an outer periphery of the lighting film and including both surfaces having adhesiveness on a side of the incident light and a side of the emitted light, wherein at least one of a peeling strength and a shear strength on the side of the incident light is less than that on the side of the emitted light.

### Advantageous Effects of Invention

According to one aspect of the present invention, the lighting device that can be easily attached to and removed from the panel can be provided.

### BRIEF DESCRIPTION OF DRAWINGS

FIG. 1 is a conceptual diagram illustrating a lighting device according to a first embodiment.

FIG. 2 is a schematic cross-sectional view taken along II-II of FIG. 1.

FIG. 3 is a conceptual diagram illustrating a lighting device according to a second embodiment.

FIG. 4 is a schematic cross-sectional view taken along IV-IV of FIG. 3.

FIG. 5 is a conceptual diagram illustrating a lighting device according to a third embodiment.

FIG. 6 is a schematic cross-sectional view taken along VI-VI of FIG. 5.

FIG. 7 is a schematic cross-sectional view illustrating a lighting device according to a fourth embodiment.

FIG. 8 is a conceptual diagram illustrating a lighting device according to another embodiment.

FIG. 9A is a conceptual diagram of the time when ambient temperature of the lighting device becomes a tow temperature in a case where polyethylene terephthalate is used for a material of a base material.

FIG. 9B is a conceptual diagram of the time when a lighting film shrinks due to a change in the ambient temperature of the lighting device in a case where polyethylene terephthalate is used for the material of the base material.

FIG. 10 is a conceptual diagram in a case where acrylic foam is used for the material of the base material.

FIG. 11 is a comparative table which experimental results of example 1 and example 2 are compared.

FIG. 12 is a schematic cross-sectional view illustrating a lighting device according to a sixth embodiment.

### DESCRIPTION OF EMBODIMENTS

Embodiments of the present invention will be described below with reference to the drawings.

### First Embodiment

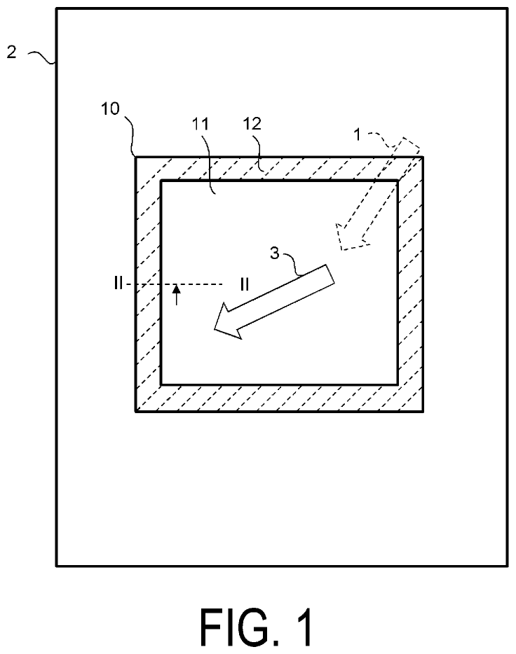

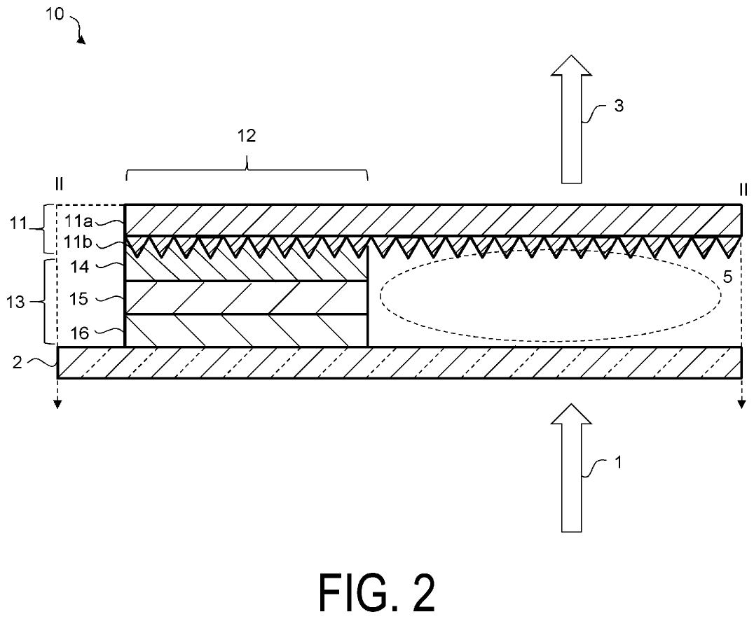

FIG. 1 illustrates a lighting device 10 according to the present embodiment. FIG. 2 is a schematic cross-sectional view taken along II-II of FIG. 1. As illustrated in FIG. 1, incident light 1 being light such as sunlight entering a panel 2 and a lighting device 10 is emitted as emitted light 3 toward a prescribed direction by a prism layer 11b included in a lighting film 11. The lighting film 11 includes a base material 11a for providing rigidity, for example, in addition to the prism layer 11b.

In this manner, for example, the incident light 1 coming from the outdoors is emitted as the emitted light 3 to the indoors by the lighting device 10 that adheres to the indoor side of the panel 2. Note that the panel 2 is made of, for example, a transparent plate-like glass, resin, or the like, which is used for a window of a building, a vehicle, or the like.

As illustrated in FIG. 2, an adhesive adhering part 12 that is provided on the entire outer periphery of the lighting film 11 in the lighting device 10 causes the lighting film 11 and the panel 2 to adhere to each other by using a double-sided adhesive 13. In this manner, since the double-sided adhesive 13 adheres only to the outer periphery and does not adhere to the entire surface of the lighting film 11, the lighting device 10 can be easily peeled from the panel 2.

The double-sided adhesive 13 includes adhesive materials 14 and 16 each having adhesiveness and a base material 15 having rigidity. The adhesive material 14 causes the lighting film 11 and the base material 15 to adhere to each other, and the adhesive material 16 causes the base material 15 and the panel 2 to adhere to each other.

At least one of the peeling strength and the shear bonding strength of the adhesive material 16 on the incident light 1 side of the double-sided adhesive 13 (a side proximate to the panel 2) is less than that of the adhesive material 14 on the emitted light 3 side of the double-sided adhesive 13 (a side proximate to the lighting film 11). Thus, the lighting device 10 can be easily peeled from the panel 2, and the lighting device 10 can maintain adhesion between the lighting film 11 and the double-sided adhesive 13 when the lighting device 10 is peeled from the panel 2.

The prism layer 11b included in the lighting film 11 has a three-dimensional structure and has a reduced bonding surface at the time of bonding. For this reason, to enable bonding with such a small bonding surface, a material having a prescribed value or greater of an adhesive force, peeling strength, and shear bonding strength is selected as the adhesive material 14. In addition, the adhesive material 16 is set to have a prescribed value of an adhesive force, peeling strength, and shear bonding strength.

Thus, when the lighting device 10 is peeled from the panel 2, a part of the double-sided adhesive 13 and the lighting film 11 can be inhibited from remaining on the panel 2, and accordingly, a load on the panel 2 can be reduced, and in addition, the lighting device 10 can be more easily removed front the panel 2.

For example, as the adhesive material 14, for example, an acrylic adhesive material having a peeling strength of 2 N/cm or greater and a shear bonding strength of 1 N/cm² or greater, which are evaluation results in a peeling test at 90°, is used. For example, as the adhesive material 16, for example, an acrylic or silicone adhesive material having a peeling strength of 2 N/cm or less and a shear bonding strength of 1 N/cm² or greater, which are as evaluation results in a peeling test at 90°, is used. One example of such an adhesive material is a self-adsorption adhesive.

The double-sided adhesive 13 serves as a spacer, and thus an air layer 5 is secured between the panel 2 and the lighting film 11 in a part other than the adhesive adhering part 12.

At the part where the air layer 5 is secured, a refractive index of the prism layer 11b included in the lighting film 11 is prevented from being reduced, and this can inhibit direct leakage light from being generated at the part where the air layer 5 is secured. At the part where the air layer 5 is secured, tip ends of projecting portions of the prism layer 11b are not crushed by the double-sided adhesive 13, and this can prevent glare from occurring.

Note that, in the double-sided adhesive 13 according to the present embodiment, the base material 15 is provided between the adhesive material 14 and the adhesive material 16 in order to enhance flexural rigidity of the double-sided adhesive 13. The flexural rigidity of the double-sided adhesive 13 is adjusted by changing the thickness of the base material 15 and a material of the base material 15.

The flexural rigidity of the double-sided adhesive 13 is basically set greater than the rigidity of the lighting film 11, in order that the lighting device 10 is easily peeled from the panel 2 and that flatness of the lighting film. 11 is maintained (deflection and wrinkles are inhibited from being generated in the lighting film 11). Note that, in a case where the rigidity of the lighting film 11 is greater than a known general value, the flexural rigidity of the double-sided adhesive 13 need not be set greater than the rigidity of the lighting film 11.

To prevent the prism layer 11b from coming into contact with the panel 2, the thickness of the double-sided adhesive 13 is set greater than the thickness of the prism layer 11b. Note that the adhesive material 14 and the adhesive material 16 may be directly coupled to each other without providing the base material 15.

For example, in a case where the prism layer 11b included in the lighting film 11 has a thickness of 100 μm, the thickness of the double-sided adhesive 13 is set to be great enough, specifically 150 μm or greater, in order that deflection and wrinkles are inhibited from being generated in the lighting film 11.

As described above, according to the lighting device 10 of the present embodiment, at least one of the peeling strength and the shear bonding strength of the adhesive material 16 is less than that of the adhesive material 14 on the emitted light 3 side (proximate to the lighting film 11), and thus the lighting device 10 that can be easily attached to and removed from the panel 2 can be provided. For similar reasons, according to the lighting device 10 of the present embodiment, the lighting device 10 with a reduced load on the panel 2 can be provided.

In addition, according to the lighting device 10 of the present embodiment, the air layer 5 is secured, and thus at the part where the air layer 5 is secured, the refractive index of the prism layer 11b is not reduced, with the result that expected polarization performance can be achieved. In addition, at the part where the air layer 5 is secured, the tip ends of the projecting portions of the prism layer 11b are not crushed by the double-sided adhesive 13, and thus glare can be prevented from occurring.

### Second Embodiment

In the first embodiment, a case is described in which the adhesion area of the adhesive material 14 and the adhesion area of the adhesive material 16 are the same as each other. According to the present embodiment, by contrast, the adhesion areas of the adhesive material 14 and the adhesive material 16 need not be the same as each other.

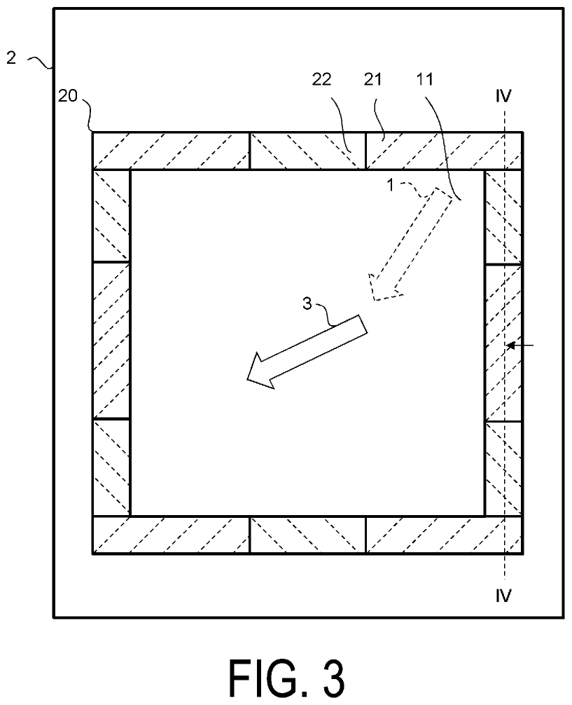

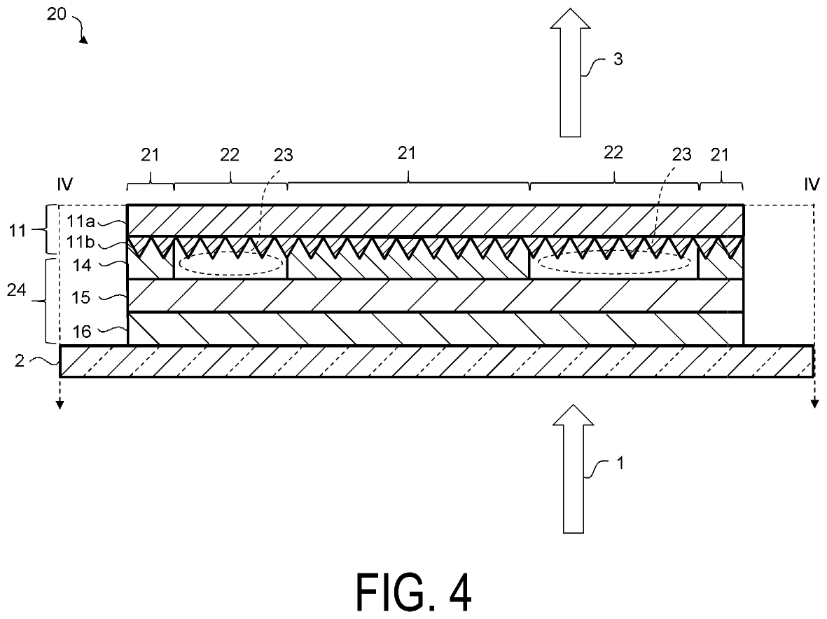

FIG. 3 illustrates a lighting device 20 according to the present embodiment. FIG. 4 is a schematic cross-sectional view taken along IV-IV of FIG. 3. As illustrated in FIG. 3, two types of adhesive adhering parts 21 and 22 are provided on the outer periphery of the lighting film 11.

As illustrated in FIG. 2, the adhesive adhering part 21 includes the adhesive materials 14 and 16 and the base material 15, similarly to the adhesive adhering part 12 according to the first embodiment. In the adhesive adhering part 22, a gap part 23 is provided instead of the adhesive material 14. Since the gap part 23 is provided, the adhesion area of the adhesive material 14 and the adhesion area of the adhesive material 16 are different from each other.

A double-sided adhesive 24 that causes the lighting film 11 and the panel 2 to adhere to each other in the present embodiment includes the adhesive materials 14 and 16 and the base material 15, similarly to the first embodiment.

Between the panel 2 and the base material 15, the adhesive material 16 adheres to the panel 2 and the base material 15 at the entire outer periphery, and thus bonding strength of the lighting device 20 with respect to the panel 2 is not reduced compared to the bonding strength of the lighting device 10 according to the first embodiment with respect to the panel. Note that the bonding strength is a value calculated by multiplying the shear bonding strength and the adhesion area of the adhesive materials 14 and 16.

Between the lighting film 11 and the base material 15, the gap part 23 is provided instead of the adhesive material 14 and a space in which the lighting film 11 can move is secured, and thus stress applied to the double-sided adhesive 24 can be relieved when the lighting film 11 deforms due to thermal expansion or shrinkage, for example. Since the gap part 23 is provided, direct leakage light can be inhibited from being generated in the adhesive adhering part 22.

For example, as illustrated in FIG. 3, the adhesive adhering part 21 is provided at each of four corners of the lighting film 11 and occupies a half or more of the length of each side of the lighting film 11. An outer peripheral part of the lighting film 11 other than the adhesive adhering part 21 is referred to as an adhesive adhering part 22.

Even when the adhesion area of the adhesive material 14 is reduced as in the present embodiment, the adhesive force, the peeling strength, and the shear bonding strength of the adhesive material 14 have a prescribed value or greater, and this allows the lighting film 11 and the base material 15 not to be peeled from each other. Here, the prescribed value is a value at which the adhesive material 14 can withstand weight that is 10 times as much as the weight of the lighting film 11, for example, in the area of the adhesive adhering part 12.

For example, the long side of the lighting film 11 is set to 1000 mm, the short side is set to 650 mm, and the weight is set to 300 g, and the adhesive material 14 is caused to adhere to the entire periphery of the lighting film 11 with the width of 15 mm. In this case, the adhesion area of the adhesive material 14 is 486 cm², as calculated according to Equation (1).

62 cm×1.5 cm×2+100 cm×1.5 cm×2=486 cm² (1)

In a case where the shear bonding strength of the adhesive material 14 is 1 N/cm², the bonding strength of the adhesive material 14 is 486 N as calculated according to Equation (1) and the weight of an object having a mass of 1 kg is approximately 9.81 N, and accordingly the adhesive material 14 can withstand the weight of approximately 49 kg.

Even in a case where the adhesion area of the adhesive material 14 is 243 cm², which is the half of the above-mentioned case, the bonding strength of the adhesive material 14 is 243 N, and accordingly the adhesive material 14 can withstand the weight of 25 kg. Even in a case where the weight of the lighting film 11 is 300 g (0.3 kg) and the adhesion area of the adhesive material 14 is 243 cm², which is the half of the above-mentioned case, the adhesive material 14 can withstand weight that is approximately 100 times as much as the weight of the lighting film 11.

As described above, according to the lighting device 20 of the present embodiment, the adhesion area of the adhesive material 14 is reduced, and thus the lighting device 10 that can be more easily attached to and removed from the panel 2 than in the first embodiment can be provided. According to the lighting device 10 of the present embodiment, the lighting device 10 with a more reduced load on the panel 2 than that in the first embodiment can be provided.

In addition, according to the lighting device 20 of the present embodiment, the air layer 5 is secured similarly to the first embodiment, and thus at the part where the air layer 5 is secured, the refractive index of the prism layer 11b is not reduced, with the result that expected polarization performance can be achieved. In addition, at the part where the air layer 5 is secured, the tip ends of the projecting portions of the prism layer 11b are not crushed by the double-sided adhesive 13, and thus glare can be prevented from occurring.

In addition, according to the lighting device 20 of the present embodiment, in the adhesive adhering part 21 in which the gap part 23 is provided, the tip ends of the projecting portions of the prism layer 11b are not crushed by the adhesive material 14, and thus glare can be prevented from occurring.

### Third Embodiment

In the first and second embodiments, a case in which a single type of the adhesive material 16 is used for adhesion to the panel 2. According to the present embodiment, by contrast, a material other than the adhesive material 16 may be used for a part of the adhering part to the panel 2.

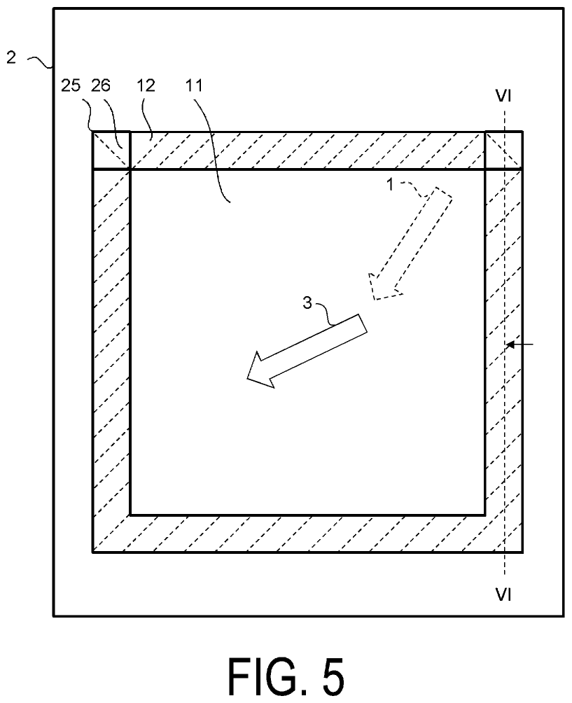

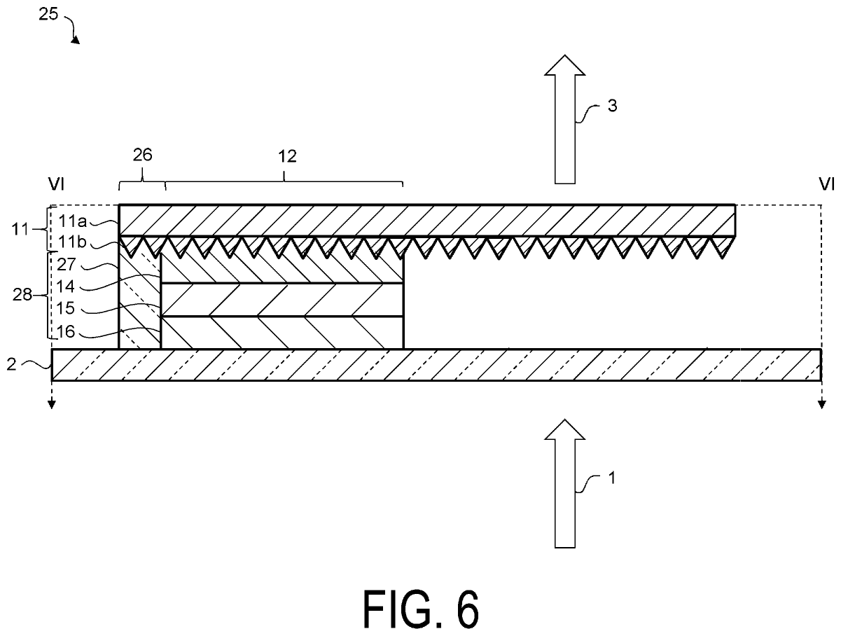

FIG. 5 illustrates a lighting device 25 according to the present embodiment. FIG. 6 is a schematic cross-sectional view taken along VI-VI of FIG. 5. As illustrated in FIG. 5, an adhesive adhering part 26 is provided in a part of the outer periphery of the lighting film 11, in addition to the adhesive adhering part 12.

The adhesive adhering part 12 of a double-sided adhesive 28 that causes the lighting film 11 and the panel 2 to adhere to each other in the present embodiment includes the adhesive materials 14 and 16 and the base material 15, similarly to the first and second embodiments. As illustrated in FIG. 6, the adhesive adhering part 26 of the double-sided adhesive 28 causes the lighting film 11 and the panel 2 to adhere to each other by using an adhesive material 27.

In a case where at least one of the peeling strength and the shear bonding strength of the adhesive material 27 is greater than that of the adhesive material 16, for example, the lighting device 25 can remain adhering to the panel 2 by the adhesive material 27 even when the peeling strength, the shear bonding strength, or the like of the adhesive material 16 is reduced due to time degradation.

In this manner, since defect modes being characteristics of deterioration of the materials of the adhesive material 16 and the adhesive material 27 differ from each other, the possibility that the lighting device 25 detaches from the panel 2 and drops can be reduced.

It is only necessary that at least one of the peeling strength and the shear bonding strength of the adhesive material 27 be greater than that of the adhesive material 16, and the adhesive material 14 and the adhesive material 27 may be made of the same material or may be made of different materials. Note that, since the peeling strength and the shear bonding strength of the adhesive material 27 have a prescribed value or greater, the lighting device 25 and the panel 2 can adhere to each other by only the adhesive adhering part 26. Here, the prescribed value is a value at which the adhesive material 27 can withstand weight that is 10 times as much as the weight of the lighting film 11, for example, in the area of the adhesive adhering part 26.

For example, the lighting film 11 has a square shape with each side of 650 mm and a weight of 200 g, the adhesive adhering part 26 has a square shape with each side of 15 mm, and the adhesive material 27 has a shear bonding strength of 50 N/cm². In this case, the bonding strength of the adhesive material 27 is 225 N as calculated according to Equation (2) and the weight of an object having a mass of 1 kg is approximately 9.81 N, and accordingly the adhesive material 27 can withstand the weight of approximately 23 kg.

1.5 cm×1.5 cm×2×50 N/cm²=225 N (2)

Even in a case where the weight of the lighting film 11 is 200 g (0.2 kg) and the adhering part of the adhesive material 27 is only the adhesive adhering part 26, the adhesive material 27 can withstand weight that is approximately 100 times as much as the weight of the lighting film 11.

The position of the adhesive adhering part 26 may be two corners on the upper side in the vertical direction as illustrated in FIG. 5 in order to provisionally fix the lighting device 25 and facilitate attachment of the lighting device 25 to the panel 2. Alternatively, the adhesive adhering part 26 may be located at one position or may be located at three or more positions, and the position of the adhesive adhering part 26 is not limited to the two corners on the upper side in the vertical direction.

With the adhering part of the adhesive material 27 being smaller than the adhering part of the adhesive material 14, the lighting device 25 can be attached to and removed from the panel 2 as easily as the lighting devices 10 and 20 according to the first and second embodiments.

For similar reasons, the load applied to the panel 2 by the lighting device 25 can be made closer to the load applied to the panel 2 by the lighting devices 10 and 20 according to the first and second embodiments.

As described above, the lighting device 25 according to the present embodiment can be easily attached to and removed from the panel 2 in a manner similar to the first embodiment, and in addition, since the lighting device 25 adheres to the panel 2 by the adhesive material 16 and the adhesive material 27 having different defect modes, the possibility that the lighting device 25 detaches from the panel 2 and drops can be reduced.

In the present embodiment, a case is described in which a material other than the adhesive material 16 is used for a part of the adhering part to the panel 2 in the first embodiment. However, similar effects can be obtained even when a material other than the adhesive material 16 is used for a part of the adhering part to the panel 2 in the second embodiment.

### Fourth Embodiment

In the first to third embodiments, there is no particular description on the patterns of the adhesive adhering parts 12, 21, 22, and 26. In the present embodiment, however, patterns may be provided for the adhesive adhering parts 12, 21, 22, and 26 by applying a print to the base material 15.

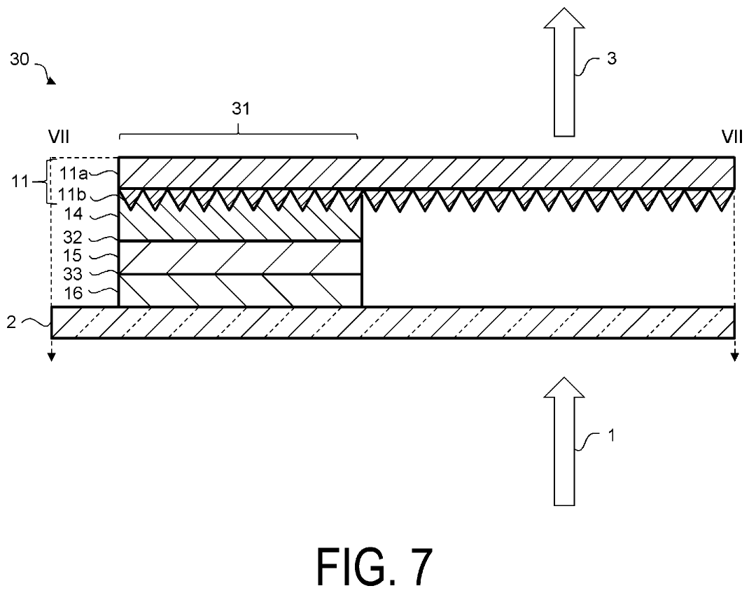

In the present embodiment, a transparent material is used for the adhesive materials 14 and 16 in order to make printing on the base material 15 effective, and base material surfaces 32 and 33 of the base material 15 of the lighting device 30 illustrated in FIG. 7 can be visually recognized from the panel 2 side and the lighting film 11 side.

The cross-sectional view taken along VII-VII in FIG. 7 illustrates a case in which a pattern is provided for the base material surfaces of the base material 15 in the case of the first embodiment. The base material surface 32 faces the lighting film 11, and can thus be visually recognized from the emitted light 3 side (for example, the indoor side). The base material surface 33 faces the panel 2, and can thus be visually recognized from the incident light 1 side (for example, the outdoor side).

When a transparent material is used for the base material 15, a print on the base material 15 can be visually recognized from both of the sides of the incident light 1 and the emitted light 3. For example, when a print is applied to the base material surface 32, the print of the base material surface 32 can be visually recognized from the emitted light 3 side (for example, the indoor side) and the print of the base material surface 32 can be visually recognized from the incident light 1 side (for example, the outdoor side) as well. Note that, when a print of a letter or a left-right asymmetric pattern is applied to the base material surface 32, the print can be visually recognized as mirror writing from the incident light 1 side (for example, the outdoor side), or the print can be visually recognized with the right and left sides of its pattern being reversed.

In a similar manner, for example, when a print is applied to the base material surface 33, the print of the base material surface 33 can be visually recognized from the incident light 1 side (for example, the outdoor side), and the print of the base material surface 33 can be visually recognized from the emitted light 3 side (for example, the indoor side) as well, Note that, when a letter or a left-right asymmetric pattern is printed on the base material surface 33, the print can be visually recognized as mirror writing from the emitted light 3 side (for example, the indoor side), or the print can be visually recognized with the right and left sides of its pattern being reversed.

When a print is applied to the base material 15, the incident light 1 impinges on the printed part, and thus direct leakage light, which is generated because the prism layer 11b of the lighting film 11 is covered by the adhesive material 14, can be blocked and reduced.

The print applied to the base material 15 can achieve consistency with a frame part of the panel 2, and can enhance external appearance of the incident light 1 side (for example, the outdoor side) and the emitted light 3 side (for example, the indoor side). In addition, because of the print applied to the base material 15, unevenness of the adhesion of the adhesive materials 14 and 16 can be made less noticeable, which can enhance external appearance of the incident light 1 side (for example, the outdoor side) and the emitted light 3 side (for example, the indoor side).

Incidentally, since the base material 15 and the adhesive material 16 are transparent, when a print of a dark color is applied to the base material 15, the incident light 1 is more easily absorbed into the panel 2 through the base material 15, which raises a possibility that the panel 2 is deformed or damaged.

When a pattern of a dark color or the like is intended to be visually recognized on the emitted light 3 side, with white being selected as the color of the material of the base material 15, the base material 15 reflects the incident light 1, and thus heat of the incident light 1 can be inhibited from being absorbed into the panel 2 through the base material 15.

Note that a case is described in which the adhesive materials 14 and 16 are transparent and the base material 15 are colored. However, the present embodiment is not limited to this, and the adhesive materials 14 and 16 may be colored. For example, in a case where the adhesive material 16 is made white instead of making the base material 15 white, heat of the incident light 1 can be inhibited from being absorbed into the panel 2.

As described above, according to the lighting device 30 of the present embodiment, since a print is applied to the base material surfaces 32 and 33 of the base material 15, the direct leakage light can be blocked and reduced and external appearance can be enhanced.

In the present embodiment, a case is described in which a print is applied to the base material surfaces 32 and 33 of the base material 15 in the first embodiment. However, similar effects can be obtained even when a print is applied to the base material surfaces 32 and 33 of the base material 15 in the second and third embodiments.

In the first to fourth embodiments, a case is described in which the adhesive material 16 adheres to the entire outer periphery of the lighting film 11. However, the adhesive material 16 may adhere to a part of the outer periphery of the lighting film 11. As another embodiment, the adhesive material 16 may adhere to a center part as well as to the entire outer periphery of the lighting film 11.

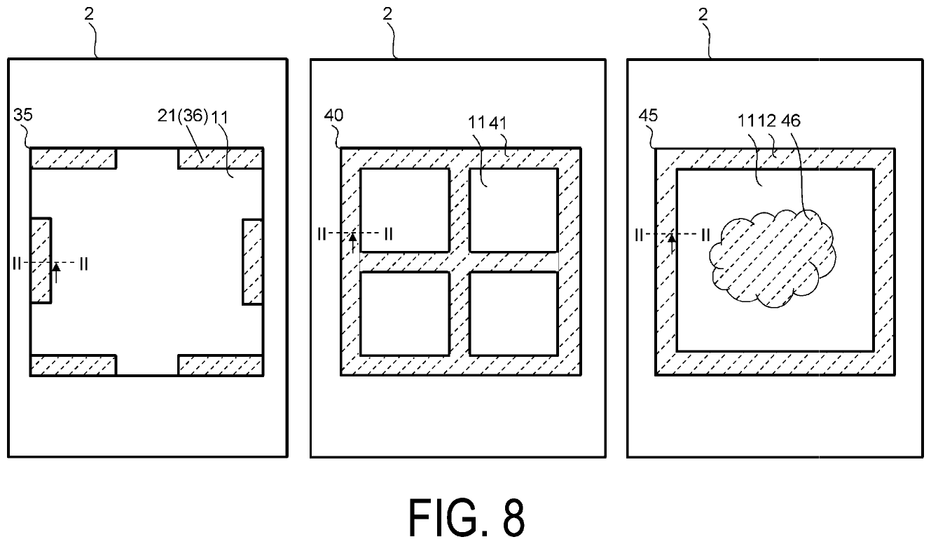

For example, as illustrated in a lighting device 35 of FIG. 8, such an adhesive adhering part 21 that a double-sided adhesive 36 adheres to a part of the outer periphery of the lighting film 11 may only be provided. For example, similarly to the second embodiment, the adhesive adhering part 21 is provided at four corners of the lighting film 11 and occupies a half or greater of the length of each side of the lighting film 11.

In a case where the area in which the lighting device 35 and the panel 2 adhere to each other by the adhesive material 16 is reduced, stress applied to the double-sided adhesive 36 can be relieved compared to a case in the second embodiment when the lighting film 11 deforms due to thermal expansion or shrinkage, for example. Note that, in a part of the outer periphery of the lighting film 11 where the adhesive adhering part 21 is not provided, a space is formed, and thus the direct leakage light can be inhibited from being generated.

Although the bonding strength of the lighting device 35 with respect to the panel 2 is reduced compared to the bonding strength of the lighting device 10 according to the first embodiment with respect to the panel 2, the adhesive force, the peeling strength, and the shear bonding strength of the adhesive material 16 have a prescribed value or greater, and the lighting device 35 and the panel 2 can be made not to peel from each other unless peeling is intended. Here, the prescribed value is a value at which the double-sided adhesive 36 (in particular, the adhesive material 16) can withstand weight that is 10 times as much as the weight of the lighting film 11, for example, in the area of the adhesive adhering part 21.

For example, the long side of the lighting film 11 is set to 1000 mm, the short side is set to 650 mm, and the weight is set to 300 g, and the adhesive material 16 is caused to adhere to the entire periphery of the lighting film 11 with the width of 15 mm. In this case, the adhesion area of the adhesive material 16 is 486 cm², as calculated according to Equation (1).

In a case where the shear bonding strength of the adhesive material 16 is 1 N/cm², the bonding strength of the adhesive material 16 is 486 N as calculated according to Equation (2) and the weight of an object having a mass of 1 kg is approximately 9.81 N, and accordingly the adhesive material 16 can withstand the weight of approximately 49 kg.

Even in a case where the adhesion area of the adhesive material 16 is 243 cm², which is the half of the above-mentioned case, the bonding strength of the adhesive material 16 is 243 N, and accordingly the adhesive material 16 can withstand the weight of 25 kg. Even in a case where the weight of the lighting film 11 is 300 g (0.3 kg) and the adhesion area of the adhesive material 16 is 243 cm², which is the half of the above-mentioned case, the adhesive material 16 can withstand weight that is approximately 100 times as much as the weight of the lighting film 11.

For example, as illustrated as an adhesive adhering part 41 of a lighting device 40 of FIG. 8, the adhesive materials 14 and 16 may adhere as a cross at a center part of the lighting film 11 in addition to the outer periphery of the lighting film 11.

In addition, for example, as illustrated as an adhesive adhering part 46 of a lighting device 45 of FIG. 8, the adhesive materials 14 and 16 may adhere to a wide area around the center part of the lighting film 11 in addition to the adhesive adhering part 12 provided on the outer periphery of the lighting film 11.

When the adhesion area of the adhesive materials 14 and 16 is increased due to the adhesive materials 14 and 16 adhering to the center part as with the case in the lighting devices 40 and 45, the bonding strength of the adhesive materials 14 and 16 is increased, and the lighting devices 40 and 45 having a size larger than those of the first to fourth embodiments can be produced.

Note that, in a case where the lighting devices 40 and 45 are combined with the fourth embodiment, a letter and a design can be represented at the center part of the lighting devices 40 and 45.

### Fifth Embodiment

In the first to fourth embodiments, a case is described in which characteristics of the base material 15 are not particularly taken into consideration. However, the present embodiment is not limited to this case. In the present embodiment, the base material 15 has prescribed flexibility not only when ambient temperature is a high temperature, but also when ambient temperature is a low temperature (for example, from −20° C. to 0° C.) and a room temperature (for example, from 0° C. to 40° C.).

For example, in a case where the base material 15 has the prescribed flexibility also when the ambient temperature is a low temperature and a room temperature in the first embodiment, the lighting device 10 can also relieve stress generated between the panel 2 and the lighting film 11 also in the case of the low temperature and the room temperature. The stress generated between the panel 2 and the lighting film 11 causes the lighting film 11 to be peeled from the panel 2. When the stress is relieved, the lighting film 11 is inhibited from being peeled from the panel 2.

The stress between the panel 2 and the lighting film 11 is generated for a reason that there is a difference between the thermal expansion coefficients of the panel 2 and the lighting film 11, and the lighting film 11 shrinks due to a change in the ambient temperature of the lighting device 10, for example.

The stress generated between the panel 2 and the lighting film 11 is applied to the double-sided adhesive 13. In a case where the base material 15 included in the double-sided adhesive 13 has flexibility, the lighting device 10 can relieve the stress because the double-sided adhesive 13 deforms. The details thereof will be described later.

Examples of the material having the prescribed flexibility at the low temperature and the room temperature include a material such as a sponge that internally includes a plurality of air bubbles and rubber. When the material such as a sponge and rubber is adopted as the base material 15, the base material 15 inhibits temperature change from the panel 2 from transferring to the lighting film 11, and the lighting device 10 can reduce the stress generated between the panel 2 and the lighting film 11. Adopting the material such as a sponge and rubber as the base material 15 is particularly effective when the panel 2 is installed between the outdoors and the indoors and there is a great temperature change in the panel 2.

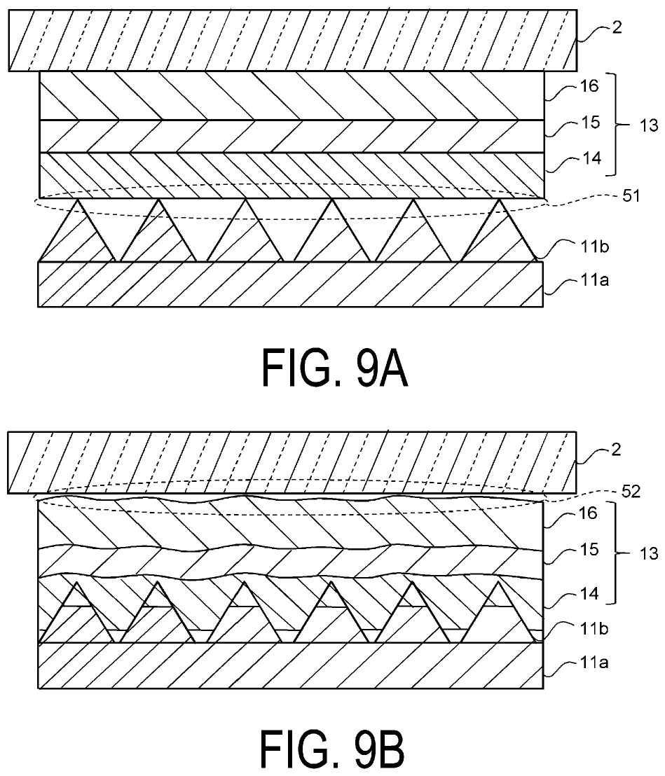

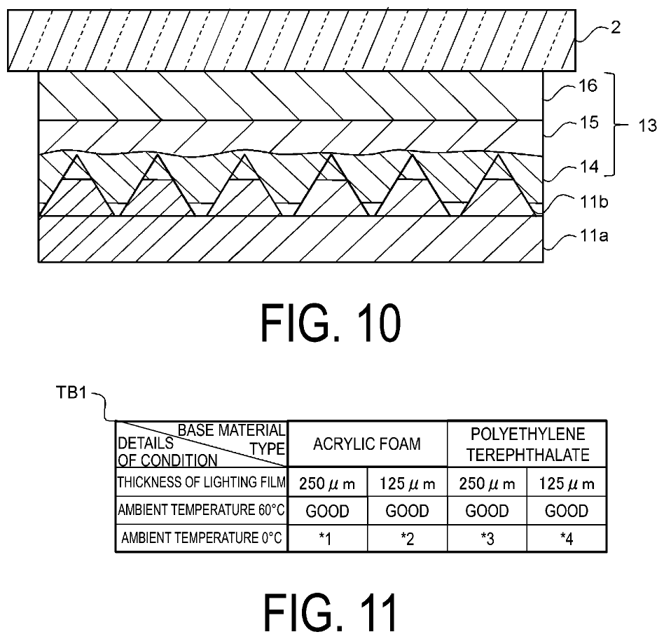

Specific description will be given using a comparative example and an example. A specific example of the first embodiment in which polyethylene terephthalate is used for the material adopted for the base material 15 is illustrated in FIG. 9A and FIG. 9B as the comparative example. A case in which acrylic foam being an example of a sponge is used for the material adopted for the base material 15 is illustrated in FIG. 10 as the example of the present embodiment.

FIG. 9A is a conceptual diagram of the time when the ambient temperature of the lighting device 10 becomes a low temperature in a case where polyethylene terephthalate is used for the material of the base material 15. FIG. 9B is a conceptual diagram of the time when the lighting film 11 shrinks due to a change in the ambient temperature of the lighting device 10 in a case where polyethylene terephthalate is used for the material of the base material 15. FIG. 10 is a conceptual diagram of a case in which acrylic foam is used for the material of the base material 15. FIG. 11 is a comparative table in which experimental results of the comparative example and the example are compared.

As illustrated in FIG. 9A, the base material 15 using polyethylene terephthalate as its material has rigidity, not flexibility, when the ambient temperature of the lighting device 10 is a low temperature (for example, from −20° C. to 0° C.). As illustrated in FIG. 9A, when the ambient temperature of the lighting device 10 is a low temperature, the double-sided adhesive 13 and the prism layer 11b as well as the base material 15 have rigidity in comparison to the case in which the ambient temperature of the lighting device 10 is not a low temperature.

When the prism layer 11b, the double-sided adhesive 13, the base material 15, and the like have rigidity, a surface 51 of the double-sided adhesive 13 has a less contact area with the lighting film 11, and the lighting device 10 is less likely to relieve the stress generated between the panel 2 and the lighting film 11.

Since the contact area of the surface 51 between the double-sided adhesive 13 and the lighting film 11 is reduced and the lighting device 10 is less likely to relieve the stress generated between the panel 2 and the lighting film 11, the lighting film 11 easily drops off from the double-sided adhesive 13 and the panel 2.

As illustrated in FIG. 9B, the adhesive material 14 deforms due to a change in the ambient temperature of the lighting device 10, and the base material 15 using polyethylene terephthalate as the material changes in a shape according to the deformation such that the cross-section is waved.

Because the base material 15 cannot absorb the stress between the panel 2 and the lighting film 11, the base material 15 deforms and, according to the deformation, the adhesive material 16 changes in a shape such that the cross-section is waved, which reduces a contact area in a surface 52 between the lighting device 10 and the panel 2.

The lighting device 10 is less likely to relieve the stress generated between the panel 2 and the lighting film 11. For this reason, as illustrated in FIG. 10, when a material having flexibility, such as acrylic foam, is used for the base material 15, the double-sided adhesive 13 absorbs the stress generated between the panel 2 and the lighting film 11 in both of a case in which the ambient temperature of the lighting device 10 is a low temperature and a case in which the ambient temperature of the lighting device 10 changes.

Since the double-sided adhesive 13 absorbs the stress generated between the panel 2 and the lighting film 11, the lighting device 10 can relieve the stress generated between the panel 2 and the lighting film 11. Specifically, the base material 15 is displaced in line with the displacement of the adhesive material 14 in which the tip ends of the prism layer 11b are embedded, so that the double-sided adhesive 13 deforms on the adhesive material 14 side thereof.

The base material 15 absorbs the stress generated between the panel 2 and the lighting film 11 from the lighting film 11 side, and does not deform on the adhesive material 16 side. For this reason, the contact area between the adhesive material 16 and the panel 2 does not change in the lighting device 10 illustrated in FIG. 10, and the lighting device 10 is inhibited from dropping from the panel 2 in a case where the ambient temperature of the lighting device 10 is a low temperature and a case in which the ambient temperature of the lighting device 10 changes as well.

As shown in a comparative table TB1 of FIG. 11, an experiment was carried out, and cases in which acrylic foam and polyethylene terephthalate were used for the materials of the base material 15 were compared. As the double-sided adhesive 13 using acrylic foam as the material of the base material 15, white acrylic foam having a thickness of 0.4 mm was adopted. As the double-sided adhesive 13 using acrylic foam as the material of the base material 15, an acrylic adhesive material having a thickness of 0.1 mm was adopted.

As shown in the table TB1, as the lighting film 11, two types of lighting films were used, namely, a lighting film including a lighting part such as the prism layer 11b on both of the surfaces thereof and having a thickness of 250 μm and a lighting film including a lighting part such as the prism layer 11b on a single side thereof and having a thickness of 125 μm. The experiment was carried out, with 60° C. being adopted in a case where the ambient temperature around the lighting device 10 was a high temperature and 0° C. being adopted in a case where the ambient temperature was a low temperature.

“GOOD” in the table TB1 indicates that the lighting device 10 was not peeled from the panel 2 and the lighting device 10 was not deflected. In the case with the ambient temperature of 60° C., there were no problems such as deflection and dropping caused in the lighting device 10, in both of the case where the material of the base material 15 was acrylic foam and the case where the material was polyethylene terephthalate, and in both of the case where the thickness was 250 μm and the case where the thickness was 125 μm.

In contrast, *1, *3, and *4 in the table TB1 indicate the length of the bonded time during which the lighting device 10 was bonded to the panel 2, with the bonded time being the longest in *1, followed by *2, *3, and *4 sequentially.

In all of the cases of *1, *2, *3, and *4, problems such as deflection and dropping were not caused for a certain period of time. After a long continuous period of time of the experiment, however, the lighting device 10 dropped in *4 and the lateral surface of the lighting device 10 was inclined in *3.

As shown in FIG. 11, it can be understood that, when a material having flexibility both in the cases in which the ambient temperature is a low temperature and a room temperature is used for the base material 15, the lighting device 10 is inhibited from dropping off from the panel 2 even in a case where the ambient temperature of the lighting device 10 is a low temperature.

When the base material 15 is made of a material such as acrylic foam having flexibility even in a case where the ambient temperature is a low temperature and a room temperature, the stress generated between the panel 2 and the lighting film 11 is relieved as described above. Since the stress generated between the panel 2 and the lighting film 11 is relieved, problems such as deflection and dropping are not caused in the lighting device 10.

Note that, as can be understood from the comparative example, even when the material of the base material 15 was resin such as polyethylene terephthalate not having flexibility in a case where the ambient temperature was a low temperature, problems such as deflection and dropping were not caused in the lighting device 10 when the ambient temperature was a high temperature.

When the ambient temperature is a high temperature, not only the base material 15 but also the double-sided adhesive 13 and the prism layer 11b have flexibility compared to the case in which the ambient temperature is a low temperature. When the ambient temperature is a high temperature, the stress generated between the panel 2 and the lighting film 11 is relieved not only by the base material 15 but also by the double-sided adhesive 13, the prism layer 11b, and the like, and thus problems such as deflection and dropping are not caused in the lighting device 10.

The comparison between *1 and *2 and the comparison between *3 and *4 show that a case in which the thickness of the lighting film 11 is thick (for example, 250 μm) is more preferable than a case in which the thickness is thin (for example, 125 μm) because problems such as deflection and dropping are inhibited from being generated in the lighting device 10.

### Sixth Embodiment

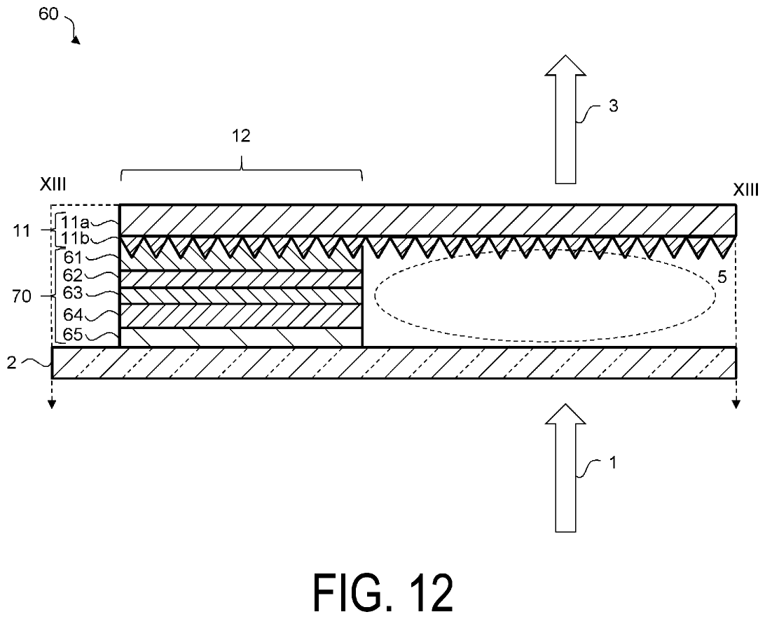

In the first to fifth embodiments, a case is described in which a single or no base material 15 is provided. As in the present embodiment, however, two or more base materials 62 and 64 may be provided. FIG. 12 is a schematic cross-sectional view illustrating a lighting device 60 according to the present embodiment.

As illustrated in the cross-sectional view taken along XIII-XIII in FIG. 12, in the present embodiment. the lighting device 60 includes the base material 62 and the base material 64. The cross-sectional view corresponding to the cross-sectional view taken along II-II in FIG. 2 is the cross-sectional view taken along XIII-XIII.

As illustrated in FIG. 12, the incident light 1 being light such as sunlight entering the panel 2 and the lighting device 60 is emitted as the emitted light 3 toward a prescribed direction by the prism layer 11b included in the lighting film 11. The lighting film 11 includes the base material 11a for providing rigidity, for example, in addition to the prism layer 11b.

In this manner, for example, the incident light 1 coming from the outdoors is emitted as the emitted light 3 to the indoors by the lighting device 60 that adheres to the indoor side of the panel 2. As illustrated in FIG. 12, the adhesive adhering part 12 that is provided on the entire outer periphery of the lighting film 11 in the lighting device 60 causes the lighting film 11 and the panel 2 to adhere to each other by using a double-sided adhesive 70. As illustrated in FIG. 1, the adhesive adhering part 12 in which the double-sided adhesive 70 adheres is provided on the entire outer periphery of the lighting film 11.

In the lighting device 60 according to the present embodiment, the double-sided adhesive 70 does not adhere on the entire surface of the lighting film 11. The double-sided adhesive 70 adheres only on the outer periphery of the lighting film 11 as in the adhesive adhering part 12, and thus an operator can easily peel the lighting device 60 from the panel 2.

The double-sided adhesive 70 includes adhesive materials 61, 63, and 65 having adhesiveness and the base materials 62 and 64. The adhesive material 61 causes the lighting film 11 and the base material 62 to adhere to each other. The adhesive material 63 causes the base material 62 and the base material 64 to adhere to each other. The adhesive material 65 causes the base material 64 and the panel 2 to adhere to each other.

In the double-sided adhesive 70, at least one of the peeling strength and the shear bonding strength of the adhesive material 65 on the incident light 1 side (a side proximate to the panel 2) is less than that of the adhesive material 61 on the emitted light 3 side (a side proximate to the lighting film 11).

Thus, the lighting device 60 can be easily peeled from the panel 2, and the lighting device 60 can maintain adhesion between the lighting film 11 and the double-sided adhesive 70 when the lighting device 60 is peeled from the panel 2.

The prism layer 11b included in the lighting film 11 has a three-dimensional structure and has a reduced bonding surface at the time of bonding. For this reason, to enable bonding with a small bonding surface, a material having a prescribed value or greater of an adhesive force, peeling strength, and shear bonding strength is selected as the adhesive material 61. In addition, the adhesive material 65 is set to have a prescribed value of an adhesive force, peeling strength, and shear bonding strength. Thus, the adhesive force of the adhesive material 65 is less than the adhesive force of the adhesive material 61.

Thus, when the lighting device 60 is peeled from the panel 2, a part of the double-sided adhesive 70 and the lighting film 11 can be inhibited from remaining on the panel 2, and accordingly, a load on the panel 2 can be reduced, and in addition, the lighting device 60 can be more easily removed from the panel 2.

For example, as the adhesive material 61, for example, an acrylic adhesive material having a peeling strength of 2 N/cm or greater and a shear bonding strength of 1 N/cm² or greater as evaluation results in a peeling test at 90° is used. For example, as the adhesive material 65, for example, an acrylic or silicone adhesive material having a peeling strength of 2 N/cm or less and a shear bonding strength of 1 N/cm² or great as evaluation results in a peeling test at 90° is used. One example of such an adhesive material is a self-adsorption adhesive. Note that it is only necessary that the adhesive material 63 be able to bond the base material 62 and the base material 64.

The double-sided adhesive 70 serves as a spacer, and thus the air layer 5 is secured between the panel 2 and the lighting film 11 in a part other than the adhesive adhering part 12. At the part where the air layer 5 is secured, a refractive index of the prism layer 11b included in the lighting film 11 is prevented from being reduced, with the result that direct leakage light can be inhibited from being generated at the part where the air layer 5 is secured. At the part where the air layer 5 is secured, tip ends of projecting portions of the prism layer 11b are not crushed by the double-sided adhesive 13, and this can inhibit glare from occurring.

Note that, in the double-sided adhesive 70 according to the present embodiment, the base material 64 is provided between the adhesive material 63 and the adhesive material 65 in order to enhance flexural rigidity of the double-sided adhesive 70. The flexural rigidity of the double-sided adhesive 70 is adjusted by changing the thickness of the base material 64 and a material of the base material 64.

The flexural rigidity of the double-sided adhesive 70 is basically set greater than the rigidity of the lighting film 11, in order that the lighting device 60 is easily peeled from the panel 2 and that flatness of the lighting film 11 is maintained (deflection and wrinkles are inhibited from being generated in the lighting film 11).

Note that, in a case where the rigidity of the lighting film 11 is greater than a known general value, the flexural rigidity of the double-sided adhesive 70 need not be set greater than the rigidity of the lighting film 11. To prevent the prism layer 11b from coming into contact with the panel 2, the thickness of the double-sided adhesive 13 is set greater than the thickness of the prism layer 11b.

The base material 62 has prescribed flexibility in order that the lighting device 60 is not peeled from the panel 2 when the ambient temperature is a low temperature and a room temperature. The prescribed flexibility is that, for example, the Young's modulus is 5 GPa or less at 0° C., desirably 1 GPa or less. Examples of the material having the prescribed flexibility include a material such as a sponge that internally includes a plurality of air bubbles, for example, acrylic foam.

In the present embodiment, the flexibility of the base material 62 is greater than the flexibility of the base material 64. In a case where the base material 62 has the prescribed flexibility also when the ambient temperature is a low temperature and a room temperature, the stress generated between the panel 2 and the lighting film 11 is relieved also in the case of the low temperature and the room temperature.

The stress generated between the panel 2 and the lighting film 11 causes the lighting film 11 to be peeled from the panel 2. When the stress is relieved, the lighting film 11 is inhibited from being peeled front the panel 2.

The stress between the panel 2 and the lighting film 11 is generated for a reason that there is a difference between the thermal expansion coefficients of the panel 2 and the lighting film 11, and the lighting film 11 shrinks due to a change in the ambient temperature of the lighting device 10, for example.

The stress generated between the panel 2 and the lighting film 11 is applied to the double-sided adhesive 70. In a case where the base material 62 included in the double-sided adhesive 70 has flexibility, the lighting device 60 can relieve the stress because the double-sided adhesive 70 deforms. Specifically, the base material 62 is displaced in line with the displacement of the adhesive material 61 in which the tip ends of the prism layer 11b are embedded, so that the double-sided adhesive 70 deforms.

Since the lighting device 60 according to the present embodiment includes the two base materials 62 and 64, the base material 64 and the adhesive material 65 located closer to the panel 2 can be changed to those having desirable characteristics according to a type of the panel 2.

For example, in a case where a surface of the panel 2 to which the lighting device 60 is attached is smooth, the base material 64 preferably has great rigidity, whereas in a case where the panel 2 is frosted glass or the like, for example, and a surface of the panel 2 to which the lighting device 60 is attached includes protrusions and recesses, the base material 64 preferably has flexibility in a case of a low temperature and a room temperature to cope with the protrusions and recesses. In a case where the panel 2 is frosted glass, the adhesive material 65 preferably has a great adhesive force in accordance with the frosted glass.

### OTHER EMBODIMENTS

In the first to sixth embodiments, a case is described in which the lighting devices 10, 20, 25, 30, and 60 include the lighting film 11 having the lighting function. Instead of the lighting film 11, an optical film including irregularly provided protrusions may be provided.

Examples of the optical film include a film having a light diffusion function of diffusing light, a light transmission function of transmitting light, a light reflection function of reflecting light, and the like. Note that the optical film may include a substrate for providing rigidity, for example.

When the lighting devices 10, 20, 25, 30, and 60 include the optical film instead of the lighting film 11, the lighting devices 10, 20, 25, 30, and 60 can have functions such as the light diffusion function, the light transmission function, and the light reflection function, other than the lighting function of emitting the incident light 1 toward a prescribed direction as the emitted light 3. Note that the optical film may have the lighting function.

1. A lighting device comprising:
a lighting film including a prism layer configured to emit incident light toward a prescribed direction as emitted light; and
a double-sided adhesive adhering to at least a part of an outer periphery of the lighting film and including both surfaces having adhesiveness on a side of the incident light and a side of the emitted light, wherein at least one of a peeling strength and a shear bonding strength on the side of the incident light is less than that on the side of the emitted light.

2. The lighting device according to claim 1,
wherein a peeling strength on the side of the incident light of the double-sided adhesive is 2 N/cm or less, a peeling strength on the side of the emitted light of the double-sided adhesive is 2 N/cm or greater, and a shear bonding strength of both the surfaces of the double-sided adhesive is 1 N/cm² or greater.

3. The lighting device according to claim 1,
wherein a thickness of the double-sided adhesive is greater than a thickness of the prism layer.

4. The lighting device according to claim 1,
wherein at least one of a peeling strength and a shear bonding strength on the side of the incident light of the double-sided adhesive is greater on a part of the outer periphery of the lighting film than in the other part.

5. The lighting device according to claim 1,
wherein the double-sided adhesive further adheres to a center of the lighting film.

6. The lighting device according to claim 1,
wherein the double-sided adhesive includes a first adhesive material on the side of the incident light, a second adhesive material on the side of the emitted light, and a base material provided between the first adhesive material and the second adhesive material.

7. The lighting device according to claim 6,
wherein the first adhesive material adheres to the entire periphery of the lighting film, and the second adhesive material adheres to a part of the outer periphery of the lighting film.

8. The lighting device according to claim 6,
wherein a print is applied to a surface of the base material on the side of the incident light, a surface of the base material on the side of the emitted light, or both surfaces of the base material.

9. A lighting device comprising:
an optical film having a protrusion and recess structure on a surface to which a panel adheres;
a first adhesive material adhering to the panel;
a second adhesive material adhering to the optical film; and
a first base material provided between the first adhesive material and the second adhesive material and having a prescribed flexibility,
wherein an adhesive force of the first adhesive material is less than an adhesive force of the second adhesive material.

10. The lighting device according to claim 9,
wherein a Young's modulus of the first base material is 1 GPa or less at 0° C.

11. The lighting device according to claim 9,
wherein the first base material internally includes a plurality of air bubbles.

12. The lighting device according to claim 9,
wherein the first adhesive material adheres to the entire periphery of the optical film, and the second adhesive material adheres to a part of an outer periphery of the optical film.

13. The lighting device according to claim 9,
wherein a print is applied to at least one surface of the first base material.

14. The lighting device according to claim 9, further comprising:
a third adhesive material provided between the first adhesive material and the first base material; and
a second base material provided between the first adhesive material and the third adhesive material.

15. The lighting device according to claim 14,
wherein a flexibility of the first base material is greater than a flexibility of the second base material.
